(19) United States
(12) Patent Application Publication
(10) Pub. No.: US 2002/0026417 A1
(43) Pub. Date: Feb. 28, 2002

(54) Method of and equipment for billing usage charge of gas turbine with intake air cooling equipment

(76) Inventors: Hidetaro Murata, Hitachi-shi (JP); Isao Takehara, Hitachi-shi (JP); Tetsuo Sasada, Hitachi-shi (JP)

Correspondence Address: MATTINGLY, STANGER & MALUR, P.C., 104 EAST HUME AVENUE, ALEXANDRIA, VA, 22301, US

(21) Appl. No.: 09/793,596

(22) Filed: Feb. 27, 2001

(30) Foreign Application Priority Data
Aug. 23, 2000 (JP) 2000-252889

(51) Int. Cl. G06F 17/60

(52) U.S. Cl. 705/40; 705/400

(57) ABSTRACT

The above object can be attained by the present invention characterized as follows: In a gas turbine power plant wherein a service provider installs intake air cooling equipment 6 of supplying water droplets in the form of fine spray into intake air equipment 4 to introduce intake air into compressor of gas turbine power plant owned by electric power company, a service provider calculates usage charge commensurate with output power increase of gas turbine produced by the operation of intake air cooling equipment based on operation data of gas turbine and intake air cooling equipment and bills electric power company for this usage charge. Therefore electric power company, and electric power company pays this usage charge for a service provider, which thus allows electric power company to use intake air cooling equipment making possible to increase gas turbine output power.

### BACKGROUND OF THE INVENTION

1. Field of the Invention

The present invention relates to a method of and equipment for billing usage charge of gas turbine power plant.

2. Description of Prior Art

The power plant powered by gas turbine has a disadvantage that the power is reduced in summer climates with high ambient temperature because of lower air density. In order to compensate this power reduction, an additional equipment provides intake air cooling equipment, disclosed in Japanese Patent No. 2877098 and others. This intake air cooling equipment is commonly installed by electric power company who owns power plant at its own expense.

However, installation of said intake air cooling equipment requires a high initial investment cost, resulting in a bigger burden to electric power company that operates power plant.

### SUMMARY OF THE INVENTION

It is an object of the present invention to achieve economical operation of power generation facility in order to reduce the burden of initial investment cost to electric power company by using intake air cooling equipment for increase of output power in gas turbine power generation facility.

In a gas turbine power plant that service provider installs intake air cooling equipment of introducing intake air in the form of fine spray into compressor in intake air equipment of gas turbine power plant owned by electric power company and makes intake air cooling equipment operative to increase output power of gas turbine, the present invention is to provide to calculate usage charge commensurate with output power increase of gas turbine produced by the fact that intake air cooling equipment has been made to operate on the basis of the operation data of gas turbine and intake air cooling equipment and to make use of intake air cooling equipment for electric power company by billing the calculated usage charge to the company.

In a gas turbine power plant that service provider installs intake air cooling equipment of introducing intake air in the form of fine spray into compressor in intake air equipment of the gas turbine power plant owned by electric power company and makes the intake air cooling equipment operative to increase output power of the gas turbine, the present invention is also to provide to install a storage unit for storing the operation status of said gas turbine and said intake air cooling equipment and to equip a data processing unit for calculating usage charge based on the data stored by said storage unit, whereby to calculate usage charge commensurate with output power increase of gas turbine brought by the fact that the data processing unit makes said intake air cooling equipment operative and to bill this usage charge for the electric power company.

### BRIEF DESCRIPTION OF THE DRAWINGS

FIG. 1 is a block diagram of the power generation system with intake air cooling equipment representing the concept of an embodiment according to the present invention;

FIG. 2 is a flow chart representing the procedure to implement present invention as in FIG. 1;

FIG. 3 is a flow chart showing a method of calculating output power increase of an embodiment provided by the data processing unit according to the present invention as in FIG. 2, based on the meteorological conditions and an amount of water droplets in the form of fine spray;

FIG. 4 is a flow chart showing a method of calculating output power increase based on the data on measured output power of another embodiment provided by the data processing unit according to the present invention as in FIG. 2;

FIG. 5 is a flow chart showing a method of calculating output power increase based on the data on planned output power and measured output power of another embodiment provided by the data processing system according to the present invention as in FIG. 2;

FIG. 6 is a flow chart representing an alteration example of a method of calculating output power increase based on the data on planned output power and measured output power of another embodiment provided by the data processing unit according to the present invention as in FIG. 2; and

FIG. 7 is a drawing representing a method of calculating usage charge of which a service provider bills an electric power company and a method of calculating compensation to be paid.

### DESCRIPTION OF THE PREFERRED EMBODIMENTS

The following explains embodiments of the present invention with reference to drawings:

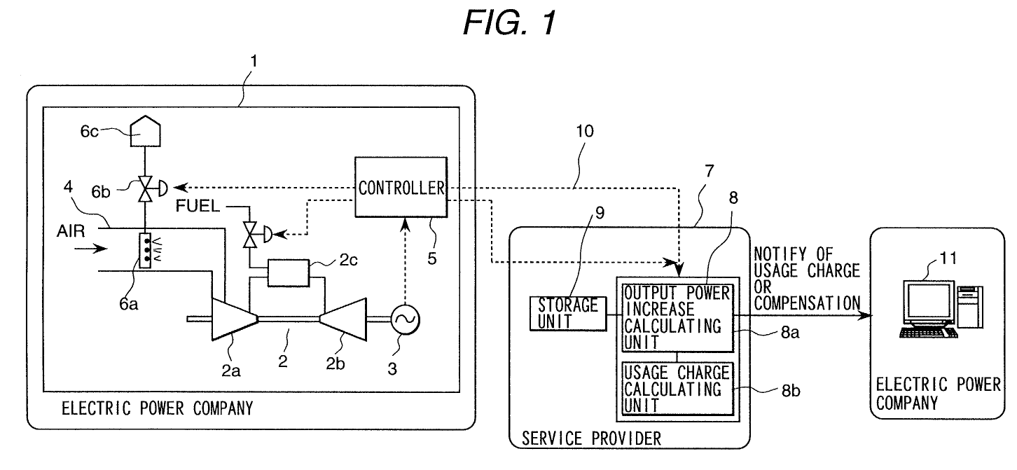

FIG. 1 is a block diagram of the gas turbine power generation system with intake air cooling equipment representing the concept of the embodiment of the present invention. Power generation facility 1 is mainly equipped with gas turbine 2, generator 3, intake air equipment 4, and a controller 5 to control them. The gas turbine comprises a compressor 2a to pressurize intake air, a combustor 2c that makes combustion of intake air introduced by compressor 2a by emitting a jet of combustion gas on the intake air, and a turbine 2b driven by combustion gas generated in combustor 2c.

Said intake air equipment 4 to introduce intake air into compressor 2a in gas turbine 2 is equipped with intake air cooling equipment 6 of moist intake air cooling type. Intake air cooling equipment is available in various types. FIG. 1 illustrates intake air cooling equipment 6 of moist intake air cooling type of introducing intake air in the form of fine spray in particle size of around 1 to 50 μm into intake air equipment 4 disclosed in Japanese Patent No. 2877098. Intake air cooling equipment is so designed as to introduce water through piping with control valve 6b from water tank 6c and to supply water droplets in the form of fine spray into intake air equipment within compressor 2a from nozzle 6a. Some water droplets supplied into intake air equipment 4 by intake air cooling equipment 6 evaporate in said intake air equipment 4 and increase the intake air density by decreasing temperature of the intake air introduced into compressor 2a, entering compressor 2a. Furthermore, unevaporated droplets are pressurized in compressor 2a to evaporate and to decrease outlet temperature of compressor 2a. Moreover, the droplets evaporated within compressor 2a become fluid for operating turbine 2b. This synergism makes gas turbine 2 increase its power.

Said intake air cooling equipment 6 is commonly installed and managed by electric power company that owns power generation facility 1 at its own expense. According to embodiments of the present invention, service provider, different from an electric power company, installs and manages power generation facility and leases the facility to electric power company. The service provider bills usage charge for electric power company and if required, pays compensation when intake air cooling equipment 6 is in trouble.

For billing usage charge of intake air cooling equipment 6 and/or for paying compensation, service provider installs data management system 7. This data management system 7 is provided with a data processing unit 8 and storage unit 9, which are made up by means of a computer. Data processing unit 8 contains a output power increase calculating unit 8a and a usage charge calculating unit 8b.

Data processing unit 8 of data management system 7 receives the operation data of gas turbine 2 and intake air cooling equipment 6 from controller 5 for operating gas turbine 2 and intake air cooling equipment 6 installed in power generation facility 4 through communications line 10 and makes storage unit 9 store the data as operation records. Based on the stored operation record data, data processing unit 8 calculates output power increase corresponding to output power of generator 3 in gas turbine 2 produced by the fact that intake air cooling equipment 6 has been made to operate, using output power increase calculating unit 8a. It also calculates usage charge commensurate with an amount of said output power increase of which service provider bills for electric power company, using usage charge calculating unit 8b. In addition, based on the operation record data, usage charge calculating unit 8b calculates compensation to be paid, as required, for electric power company when a trouble has occurred to intake air cooling equipment. Data processing unit 8 sends said usage charge and compensation obtained thereby to display unit 11 as an output unit located in electric power company, which leads to notify electric power company of the usage charge. An alteration can be made of keeping data processing unit 8 installed in electric power company to send the data on said usage charge and compensation to service provider. In addition, the data on said usage charge and compensation can be sent to service provider in the form of printed papers.

Electric power company and service provider sign an agreement of usage prior to the installation of intake air cooling equipment 6 of gas turbine power generation facility. This agreement defines the relationship of usage charge with respect to output power increase (effect) caused by usage of intake air cooling equipment in order to calculate said usage charge. It is also preferred to contain provisions on the compensation to be paid, as required, to electric power company by service provider in the event that intake air cooling equipment 6 is in trouble. In addition to said operation data, storage unit 9 also stores a usage charge calculation program and compensation calculation program, and their calculation formula (constant), and usage charge and compensation obtained by the calculation.

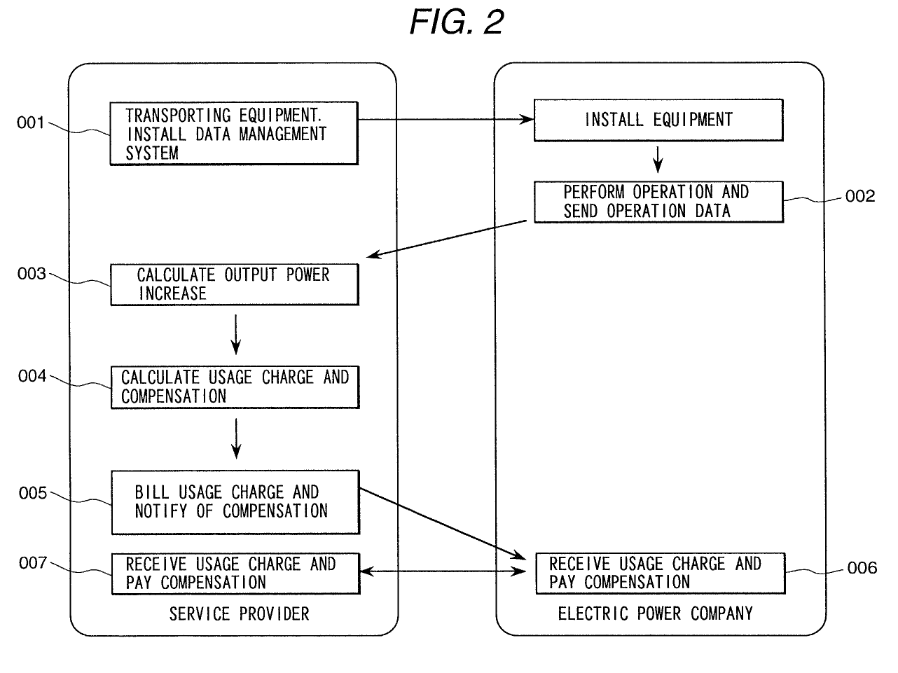

FIG. 2 is a flow chart illustrating the procedure to implement the present invention. In step 001 of installing data management system, service provider installs intake air cooling equipment, which has water tank 6c, control valve 6b and nozzle 6a to supply water droplets in the form of fine spray in particle size of 1 to 50 μm, so as to provide in intake air equipment to introduce intake air into compressor 2a in gas turbine 2 owned by electric power company and adds to controller 5 a functional means to send the operation data for calculation of usage charge and compensation in order to deliver to electric power company. The service provider also installs data management system 7.

In step 002 of sending operation data from equipment and facility, electric power company uses intake air cooling 6 to operate gas turbine power plant, power generation facility 1 and sequentially sends the operation data including output power of said intake air cooling equipment and said gas turbine to data management system 7 using controller 5.

In step 003 of calculating an amount of output power increase, service provider receives the operation data on said gas turbine 2 and said intake air cooling equipment using data management system 7 and stores the data in storage unit 9 as operation record data. Next, service provider calculates an amount of output power increase of gas turbine 2 produced by the operation of intake air cooling equipment 6 based on the operation record data stored by output power increase calculating unit 8a of data processing unit 8.

Instep 004 of calculating usage charge and compensation, service provider calculates usage charge commensurate with an amount of output power increase of said gas turbine 2 as well as compensation to be paid, as required, when a trouble has occurred to intake air cooling equipment, based on the data on an amount of output power increase calculated by said output power increase calculating unit 8a, using usage charge calculating unit 8b of data management system 7.

In step 005 of notifying electric power company of usage charge billing and compensation payment, service provider sends to electric power company the data on usage charge and compensation obtained by calculating through usage charge calculating unit of data processing unit 8 using data processing unit 8 of data management system to bill usage charge. Service provider also notifies electric power company of compensation to be paid when a trouble has occurred to intake air cooling equipment 6.

In step 006 of paying usage charge and receiving compensation, electric power company pays usage charge for service provider based on usage charge billing and receives compensation to be paid when a trouble has occurred to intake air cooling equipment.

In step 007 of receiving usage charge and paying compensation, service provider receives usage charge from electric power company based on usage charge billing and pays compensation for electric power company when a trouble has occurred to intake air cooling equipment.

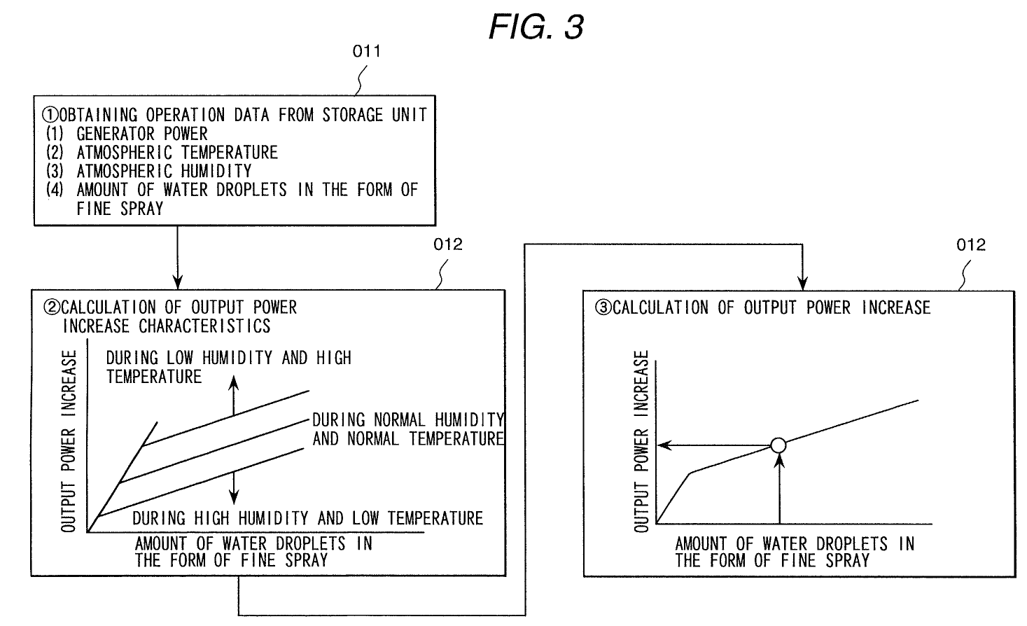

With reference to FIGS. 3 to 6, the following explains how to calculate the output power increase of gas turbine 2, power generation facility 1 provided by operation by intake air cooling equipment 6:

The degree of effect of gas turbine output power increase produced by intake air cooling equipment 6 comes different according to the atmospheric temperature and humidity. This mechanism of output power increase results from different contribution to output power increase of gas turbine between the following two effects: one is an effect of making intake air cool, which is caused by the fact that some of water droplets in particle size of 1 to 50 μm supplied in the form of fine spray from intake air cooling equipment 6 installed in intake air equipment 4 for introducing intake air into compressor 2a evaporate till the water droplets flow into compressor 2a, and the other is an effect of reducing intake air temperature at the outlet of compressor 2a, which is caused by the fact that of the water droplets, unevaporated water droplets flow into compressor 2a and said water droplets are compressed in compressor 2a and their temperature increases, finally until they evaporate. The effect of cooling intake air caused by the fact that water droplets supplied in the form of fine spray evaporate till they are introduced into compressor 2a makes a greater contribution to output power increase of gas turbine 2. This follows that under the meteorological condition of low humidity, water droplets supplied from intake air cooling equipment 6 during suction into compressor 2a evaporate with higher ratio till they flow into compressor 2a, resulting in relatively great output power increase of gas turbine.

In order to calculate such output power increase of gas turbine based on the operation of intake air cooling equipment 6, the controller 5 in power generation facility 1 detects the generated power of gas turbine 2, atmospheric temperature, atmospheric humidity, atmospheric pressure, and the amount of water droplets supplied in the form of fine spray from intake air cooling equipment 6. The detected results are sent to data management system 7 as operation data through communications line 10. The data management system 7 makes storage unit 9 store such operation data. Then output power increase calculating unit 8a in data processing unit 8 of data management system 7, as described above, calculates output power increase of gas turbine at a specified time. A service provider calculates usage charge commensurate with this output power increase and compensation to be paid when a trouble has occurred to intake air cooling equipment and notifies an electric power company that owns gas turbine 2 to bill this usage charge.

FIG. 3 is a flow chart representing a method of calculating output power increase of gas turbine based on the meteorological conditions and an amount of water droplets supplied in the form of fine spray from intake air cooling equipment. FIG. 3 corresponds to step 002 and step 003 in FIG. 2.

In step 011 of obtaining operation data from storage unit (1) according to FIG. 3, the system obtains operation data by reading data on not only generated power but also atmospheric temperature (2) and atmospheric humidity (3), which affect meteorological conditions, and an amount of water droplets supplied in the form of fine spray from intake air cooling equipment 6 in storage unit 9.

In step 012 of calculating output power increase characteristics (2), the system calculate output power increase characteristics of gas turbine with respect to an amount of water droplets in the form of fine spray under said atmospheric conditions, based on data on atmospheric temperature and atmospheric humidity obtained from storage unit 9. This output power increase characteristics are made to calculate not only about normal atmospheric temperature and atmospheric humidity but also over several cases under low humidity and high air temperature and under high humidity and low air temperature.

In step 013 of calculating an amount of output power increase (3), output power increase of gas turbine is made to calculate for amount increased in said output power increase characteristics calculated in step 012, based on the data on an amount of water droplets supplied in the form of fine spray obtained from storage unit 9.

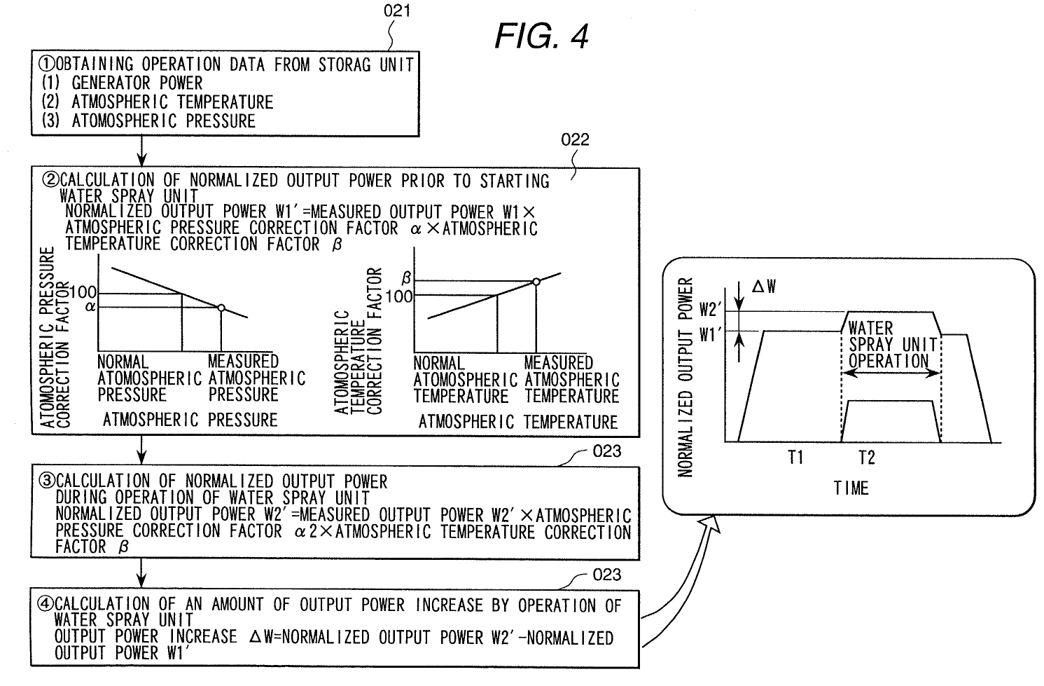

FIG. 4, different in embodiment of FIG. 3, is a flowchart representing a method of calculating output power increase of gas turbine based on measured output power data on gas turbine 2. The use of this method can calculate output power increase with high accuracy.

In step 021 of obtaining operation data from storage unit 9 (1), from storage unit 9, the system obtains operation data, that is, generator power (1), atmospheric temperature (2) and atmospheric pressure (3) before intake air cooling equipment 6 is made to operate under the rated operation (T1) of gas turbine, power generation facility 1.

In step 022 of calculating normalized output power before operating water spray unit, normalized output power W1′ is calculated when gas turbine is made to operate before using intake air cooling equipment 6. Power generation facility 1 powered by gas turbine 2 is characterized in that generator power is higher with lower atmospheric temperature and higher atmospheric pressure. In order to eliminate the error due to the difference in such atmospheric conditions, the generator power obtained from storage unit 9 is corrected into the value obtained by converting into normal atmospheric pressure and normal atmospheric temperature, which are considered as atmospheric conditions. This embodiment takes the reference atmospheric conditions as being atmospheric temperature of 15° C. and atmospheric pressure of 1013 hPa. Normalized output power W1′=Measured output power W1×Atmospheric pressure correction factor α1×Atmospheric pressure correction factor β1.

In step 023 of calculating normalized output power during operation of water spray unit (3), similarly the system calculates normalized output power W2′ when gas turbine is made to operate (T2) using intake air cooling equipment 6. Normalized output power W2′=Measured output power W2×Atmospheric pressure correction factor α2×Atmospheric temperature correction factor β2.

In step 024 of calculating output power increase by operation of water spray unit (4), comparison is made between normalized output powers W1′ and W2′ and the difference between the two (W2′−W1′) is calculated as output power increase ΔW. These relationships are given on the right side of FIG. 4, which indicates a state of increasing output power for water spray unit operating time (T2). Output power increase ΔW=Normalized output power W2′−Normalized output power W1′.

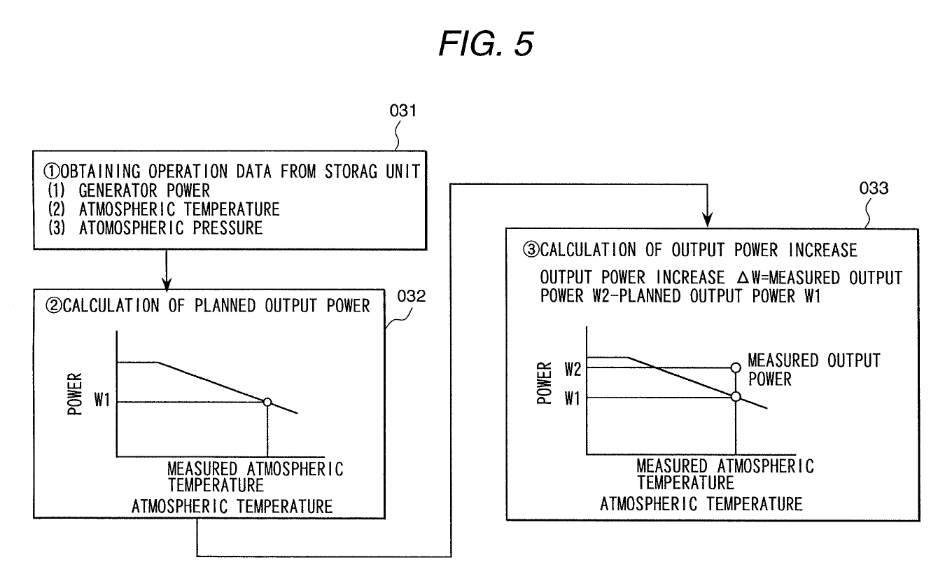

FIG. 5, another different embodiment, is a flow chart showing a method of calculating output power increase based on data on planned output power and measure output power.

In step 031 of obtaining operation data from storage unit 9 (1), operation data such as generator power (1), atmospheric temperature (2), atmospheric pressure (3) are obtained from storage unit 9.

In step 032 of calculating planned output power (2), planned output power W1 is calculated in consideration of atmospheric temperature. This planned output power W1 is theoretical generator power gained when gas turbine 2 is made to operate without use of intake air cooling equipment 6. It is calculated according to the design specifications.

In step 033 of calculating output power increase (3), difference (W2−W1) between generator power W2 measured in gas turbine 2 and planned output power W1 is calculated and this difference is assumed as being output power increase ΔW. Output power increase ΔW=Measured output power W2−Planned output power W1.

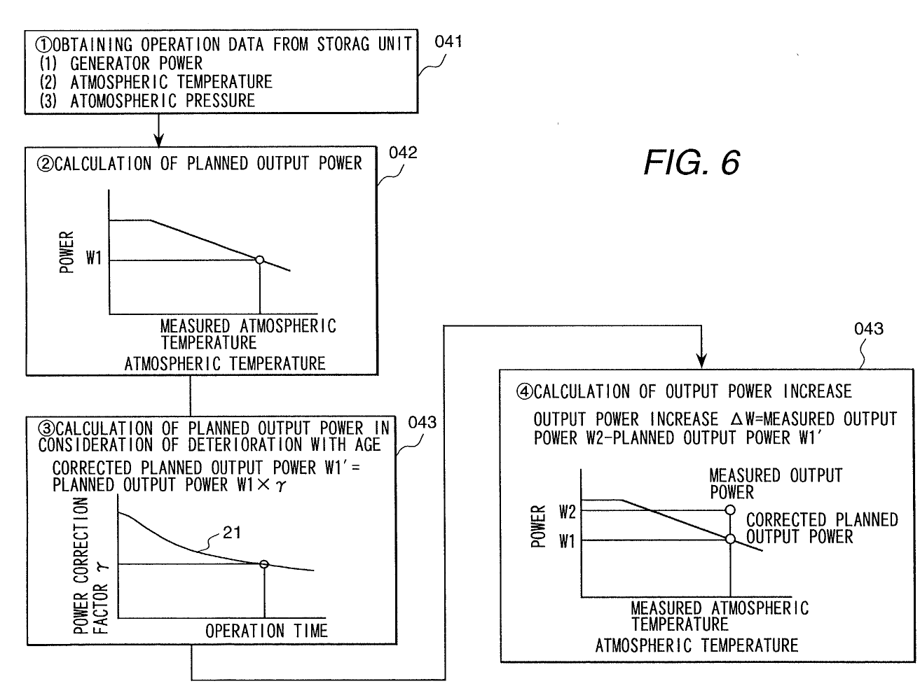

FIG. 6, another different embodiment, is a flow chart showing an alteration example of a method of calculating output power increase produced by intake air cooling equipment 6 based on the data on planned output power and measured output power. The generator power characteristics of power generation facility 1, which means gas turbine 2, deteriorate with age. So planned output power is preferred to be calculated in consideration of the characteristics which are deteriorated with age. In this alteration example, a method is adopted of calculating planned output power in consideration of deterioration of power generation facility with age.

In step 041 of obtaining operation data from storage unit (1), generator power (1), atmospheric temperature (2) and atmospheric pressure (3), which are operation data, are obtained from storage unit 9.

In step 042 of calculating planned output power (2), planned output power W1 is calculated in consideration of atmospheric temperature. This planned output power W1 implies theoretical generator power gained when gas turbine 2 is made to operate without use of intake air cooling equipment 6. It is calculated according to the design specifications.

In step 043 of calculating planned output power in consideration of deterioration with age (3), corrected planned output power W1′ is calculates by correcting planned output power W1 using secular deterioration characteristics on the basis of operation time.

In step 044 of calculating output power increase (4), calculation is made of the difference (W2−W1′) between generator power W2 measured in gas turbine and corrected planned output power W1′ and this difference is defined as power increase ΔW. Output power increase ΔW=Measured output power W2×Planned output power W1′.

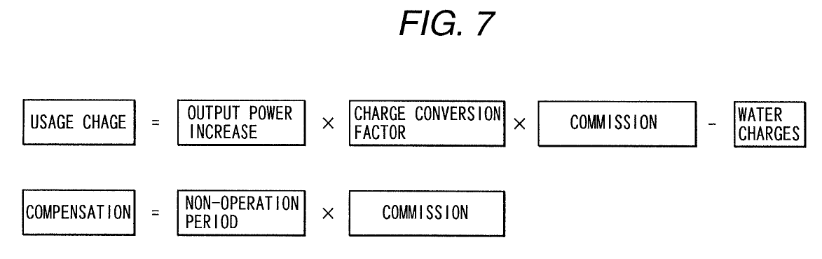

FIG. 7 shows a method of calculating usage charge of which a service provider bills an electric power company for intake air cooling equipment 6 and a method of calculating compensation to be paid for an electric power company when a trouble has occurred to intake air cooling equipment. In FIG. 7, usage charge calculating unit 8B calculates usage charge by multiplying output power increase gained by the calculation method described above by given charge conversion factor under precontract and commission. The price for power generation water used in intake air cooling equipment 6 is reduced from the result of this calculation. The result obtained is the amount to be billed. When intake air cooling equipment 6 is in trouble and cooling operation cannot be made, or power generation facility 1 is turned off to stop the operation, the non-operation period is multiplied by the precontracted commission, thereby getting the amount of compensation.

The present invention allows electric power company to eliminate an intake air cooling equipment cost from initial investment for gas turbine power generation facility in order to increase output power caused by the installation of intake air cooling equipment, and ensures effective operation for power generation using intake air cooling equipment during operation of gas turbine. In addition, electric power company simply pays usage charge commensurate with output power increase caused by increased power generation efficiency enabling economical operation of power generation facility.

What is claimed:

1. In a gas turbine power plant wherein intake air cooling equipment is installed by a service provider in intake air equipment of introducing intake air in the form of fine spray into the compressor of the gas turbine power plant owned by electric power company and is made to operate intake air cooling equipment to increase output power of gas turbine,
a method of billing usage charge of gas turbine with intake air cooling equipment, characterized in that
on the basis of the operation data of said gas turbine and said intake air cooling equipment, service provider calculates usage charge commensurate with the output power increase due to the operation of said intake air cooling equipment and bills the calculated usage charge for electric power company.

2. A method of billing usage charge of gas turbine with intake air cooling equipment according to claim 1, wherein output power increase of gas turbine is calculated on the basis of meteorological conditions and the operation status of intake air cooling equipment.

3. A method of billing usage charge of gas turbine with intake air cooling equipment according to claim 1, wherein output power increase of gas turbine is calculated on the basis of measured output power data,

4. A method of billing usage charge of gas turbine with intake air cooling equipment according to claim 1, wherein output power increase of gas turbine is calculated on the basis of the difference between planned output power and measured output power.

5. A method of billing usage charge of gas turbine with intake air cooling equipment according to claim 4, wherein output power increase of gas turbine is calculated in consideration to deterioration with gas turbine operation time.

6. In a gas turbine power plant wherein intake air cooling equipment is installed by service provider in intake air equipment of introducing intake air in the form of fine spray into compressor of gas turbine power plant owned by electric power company and is made to operate intake air cooling equipment to increase output power of gas turbine,
a method of billing usage charge of gas turbine with intake air cooling equipment, characterized in that
storage unit is installed to store the operation data of said gas turbine and said intake air cooling equipment and a data processing unit is equipped to calculate usage charge based on the data stored by said storage unit. So said data processing unit calculates usage charge commensurate with output power increase of gas turbine due to the operation of said intake air cooling equipment and service provider bills usage charge for electric power company.
